(19) United States
(12) Patent Application Publication
(10) Pub. No.: US 2009/0134125 A1
(43) Pub. Date: May 28, 2009

(54) SWITCHGEAR AND METHOD OF FABRICATING THE SAME

(75) Inventors: Naoaki Inoue, Tokyo (JP); Masahiro Arioka, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-ku, Tokyo (JP)

(21) Appl. No.: 12/294,382

(22) PCT Filed: Mar. 23, 2007
(86) PCT No.: PCT/JP2007/056062

§ 371 Date: Sep. 24, 2008

(30) Foreign Application Priority Data
Mar. 27, 2006 (JP) 2006-084479

(51) Int. Cl. H01H 33/662; H01H 11/00

(52) U.S. Cl. 218/139; 29/622

(57) ABSTRACT

A switchgear including a vacuum valve which prevents partial discharges infallibly and whose reliability is high, and a method of fabricating the same are obtained.

In a vacuum valve 1 wherein a stationary electrode 1a and a movable electrode 1b are disposed within a vacuum vessel 2 which is constituted by a metal flange 2a as well as a metal tube 2e and an insulating tube 2b, and wherein a resin mold 3 is applied onto the outer peripheral surface of the vacuum vessel 2; coiled metal-made shields 4a and 4b, in each of which a coiled metal wire is brought into an annular shape, are retained on the outer peripheral surface of the vacuum vessel so as to relax the electric fields of the electric field relaxation-requiring parts 21d of the vacuum vessel 2.

### TECHNICAL FIELD

This invention relates to a switchgear and a method of fabricating the same, more particularly a switchgear which includes a vacuum valve with the outer peripheral surface of a vacuum vessel molded with a resin and a method of fabricating the same, and it relates specifically to thermal stress relaxation and electric field relaxation which arrest the occurrences of cracks, partial discharges, etc. that develop in the resin mold when this mold has undergone a temperature change.

### BACKGROUND ART

A vacuum valve has its insulating performance ensured in such a way that the outer peripheral surface of a vacuum vessel having a movable electrode and a stationary electrode inside is molded with a resin, for example, an epoxy resin being an outer peripheral insulator (hereinbelow, termed “resin molding”).

In general, it is practiced to apply thermal stress relaxation members to only required parts, i.e., parts requiring thermal stress relaxation, not to all the outer peripheral surface of a vacuum vessel 1A (refer to, for example, Patent Document 1). Signs 3B in FIG. 8 of Patent Document 1 denote room-temperature vulcanizing type silicone rubber [hereinbelow, termed “RTV (Room Temperature Vulcanizable) rubber”] being the stress relaxation members which are applied as coatings so as to respectively cover thermal stress concentration parts 2C being the thermal stress relaxation-requiring parts of the outer peripheral surface of the vacuum vessel 1A. Incidentally, there are disposed metal-made flanges 2a which block up both the ends of a vacuum vessel 2, and a ceramics-made insulating tube 2b which forms the body portion of the vacuum vessel 2.

The RTV rubber or the like is a liquefied and viscous rubber, which is applied as the coatings to the thermal stress concentration parts 2c surrounding the outer peripheral surface of the vacuum vessel 2, to appropriate thicknesses, and is then vulcanized. Since the coating operation needs to be performed with scrupulous care so as not to involve air bubbles causing partial discharges, into the RTV rubber, much labor and a long time have been expended on the execution of the thermal stress relaxation members.

Besides, the RTV rubber differs in thermal expansion coefficient from the epoxy resin or the like which insulates the outer peripheral surface of the vacuum vessel. It is therefore apprehended that, when the vacuum vessel becomes a normal temperature of about 20° C. after having been molded at a high temperature exceeding 100° C., gaps will appear between the RTV rubber and the epoxy resin, to form causes for partial discharges.

Patent Document 1: JP-A-2002-358861 (FIG. 8)

### DISCLOSURE OF THE INVENTION

### Problems that the Invention is to Solve

This invention is intended to solve the several problems stated above, and to obtain a switchgear including a vacuum valve which infallibly prevents partial discharges and which is high in reliability, and a method of fabricating the same.

### Means for Solving the Problems

A switchgear according to this invention consists, in a switchgear including a vacuum valve in which a plurality of electrodes movable relative to each other are disposed within a vacuum vessel constituted by a conductive member and an insulating member and in which a resin mold is applied onto the outer peripheral surface of the vacuum vessel, in that an annular electrostatic shield member which contracts in its radial direction is retained on an outer peripheral surface of the vacuum vessel, thereby to relax an electric field of an electric field relaxation-requiring part of the vacuum vessel.

### Advantages of the Invention

In accordance with this invention, it is possible to obtain a switchgear including a vacuum valve which prevents partial discharges infallibly and whose reliability is high, and a method of fabricating the same.

This invention can be utilized for thermal stress relaxation for arresting the appearance of the cracks of a resin mold, and for electric field relaxation for arresting the occurrences of discharges.

### BRIEF DESCRIPTION OF THE DRAWINGS

FIG. 1 It is a sectional view, partially cut away, showing the configuration of a switchgear which includes a vacuum valve in Embodiment 1 according to this invention.

FIG. 2 It depicts a perspective view, a sectional view and a plan view of a shield member in Embodiment 1 according to this invention.

FIG. 3 It is a sectional view, partially cut away, showing the configuration of a switchgear which includes a vacuum valve in Embodiment 2 according to this invention.

### DESCRIPTION OF REFERENCE NUMERALS AND SIGNS

1 vacuum valve, 2 vacuum vessel, 2a metal flange, 2b insulating tube, 2e metal tube, 3 resin mold (external insulator), 4a, 4b coiled metal shields, 5 thermal stress relaxation member (RTV rubber), 6 conductive or semi-conductive coating material, 7 coupling agent, 21c thermal stress concentration part (thermal stress relaxation-requiring part), 21d electric field concentration part (electric field relaxation-requiring part).

### BEST MODE FOR CARRYING OUT THE INVENTION

### Embodiment 1

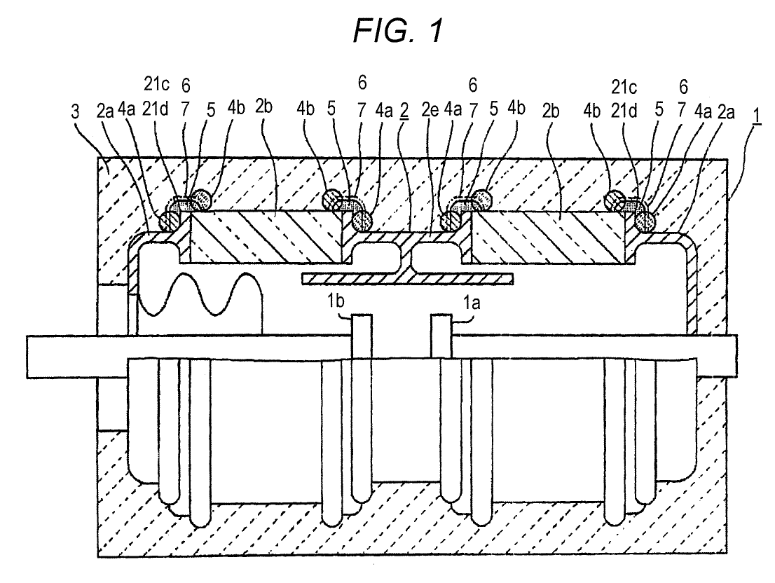

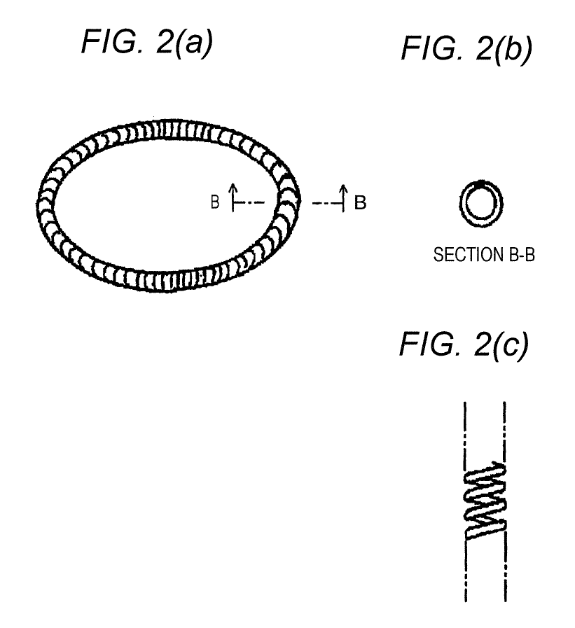

Embodiment 1 according to this invention will be described in conjunction with FIGS. 1 and 2. FIG. 1 is a sectional view, partially cut away, showing the configuration of a switchgear which includes a vacuum valve in Embodiment 1. FIG. 2 depicts a perspective view, a sectional view and a partial enlarged plan view showing the configuration of a shield member in Embodiment 1. FIG. 2(a) depicts the perspective view, FIG. 2(b) depicts the sectional view taken along line B-B in FIG. 2(a), and FIG. 2(c) depicts the partial enlarged plan view.

Referring to FIG. 1, the vacuum valve 1 is configured of a stationary electrode 1a and a movable electrode 1b, a vacuum vessel 2 which is configured of metal-made flanges 2a, a metal tube 2e and ceramics-made insulating tubes 2b and which accommodates the electrodes 1a and 1b therein, and a resin mold which is an outer peripheral insulator covering the outer peripheral surface of the vacuum vessel 2. Sign 21c denotes the thermal stress concentration part of the vacuum vessel 2, and sign 21d the electric field concentration part of the vacuum vessel 2.

The edge part 21d which protrudes in the outer peripheral direction of the vacuum vessel 2, for example, exists as the part of the outer peripheral surface of the vacuum vessel 2 corresponding to that position of the resin mold 3 which is apprehended to become a high electric field due to electric field concentration and to incur a partial discharge or the like drawback, that is, a part requiring electric field relaxation.

In order to relax the electric fields of such parts requiring the electric field relaxation, coiled metal-made shields 4a in each of which a coiled metal wire is brought into an annular shape are retained on the outer peripheral surfaces of the metal-made flanges 2a vicinal to the connection parts between these metal-made flanges 2a and the corresponding insulating tubes 2b, and the metal tube 2e vicinal to the connection parts between this metal tube 2e and the insulating tubes 2b.

The coiled metal-made shield 4a is such that a coil element which has a coil outside diameter being about 1/10 of the outside diameter of each of both end parts in the vacuum vessel 2 that is configured of the metal flanges 2a, the metal tube 2e and the ceramics-made insulating tubes 2b is formed of the comparatively fine metal wire, and that the coil element is formed into an annular member which has an inside diameter being smaller than the outside diameter of each of both end parts in the vacuum vessel 2 that includes the metal flanges 2a, in the free state thereof. As has its section shown in FIGS. 1 and 2(b) and its enlarged plan view shown in FIG. 2(c), the coiled metal-made shield 4a thus formed is fitted onto and joined with the metal flange 2a constituting the vacuum vessel 2, in a state where it is generally arranged in a direction perpendicular to the drawing sheet of FIG. 1. The fitting of the coiled metal-made shield 4a onto the metal flange 2a is performed in such a way that this coiled metal-made shield 4a is pulled against an elastic force in the direction of radially enlarging it, thereby to make the inside diameter of this coiled metal-made shield 4a larger than the outside diameter of the metal flange 2a constituting the vacuum vessel 2. The coiled metal-made shield 4a fitted on the metal flange 2a is held in pressed touch with the outer peripheral surface of the metal flange 2a constituting the vacuum vessel 2, and over its whole periphery, by the contractive force thereof. In addition, the coiled metal-made shield 4a is electrically coupled with the metal flange 2a.

The coiled metal-made shield 4a is disposed so as to protrude in the outer peripheral direction of the vacuum vessel 2 beyond the edge part 21d protrusive in the outer peripheral direction, and this coiled metal-made shield 4a and the metal-made flange 2a are electrically connected, whereby the electric field of the edge part 21d can be relaxed, and the occurrence of the partial discharge can be suppressed.

Besides, at the electric field relaxation-requiring parts formed of the edge parts 21d and in order to relax the electric fields around these parts, coiled metal-made shields 4b in each of which a coiled metal wire is brought into an annular shape are retained on the outer peripheral surfaces of the insulating tubes 2b vicinal to the connection parts between the metal-made flanges 2a and these insulating tubes 2b, and the insulating tubes 2b vicinal to the connection parts between this metal tube 2e and these insulating tubes 2b.

Likewise to the coiled metal-made shield 4a, the coiled metal-made shield 4b is such that a coil element which has a coil outside diameter being about 1/10 of the outside diameter of each of intermediate parts in the vacuum vessel 2 that includes the insulating tubes 2b is formed of the comparatively fine metal wire, and that the coil element is formed into an annular member which has an inside diameter being smaller than the outside diameter of each of the intermediate parts in the vacuum vessel 2 that includes the insulating tubes 2b, in the free state thereof. As has its section shown in FIG. 1, the coiled metal-made shield 4b thus formed is fitted onto and joined with the insulating tube 2b constituting the vacuum vessel 2, in a state where it is generally arranged in the direction perpendicular to the drawing sheet of FIG. 1. The fitting of the coiled metal-made shield 4b onto the insulating tube 2b is performed in such a way that this coiled metal-made shield 4b is pulled against an elastic force in the direction of radially enlarging it, thereby to make the inside diameter of this coiled metal-made shield 4b larger than the outside diameter of the insulating tube 2b constituting the vacuum vessel 2. The coiled metal-made shield 4b fitted on the insulating tube 2b is held in pressed touch with the outer peripheral surface of the insulating tube 2b constituting the vacuum vessel 2, and over its whole periphery, by the contractive force thereof. In addition, the coiled metal-made shield 4b is electrically coupled with the metal tube 2e.

The coiled metal-made shield 4b is disposed so as to protrude in the outer peripheral direction of the vacuum vessel 2 beyond the edge part 21d protrusive in the outer peripheral direction, and this coiled metal-made shield 4b and the metal-made flange 2a are electrically connected, whereby the electric field around the edge part 21d being the electric field relaxation-requiring part can be further relaxed, and the occurrence of the partial discharge can be arrested.

In addition to the above, the edge part 21c which protrudes in the outer peripheral direction of the vacuum vessel 2, for example, exists as the part of the outer peripheral surface of the vacuum vessel 2 corresponding to that position of the resin mold 3 which is apprehended to incur a crack or the like drawback due to thermal stress concentration, that is, a part requiring thermal stress relaxation. In order to relax thermal stresses, such thermal stress relaxation-requiring parts are coated with an RTV rubber 5 forming thermal stress relaxation members, whereupon the coiled metal-made shields 4a and 4b are retained.

The RTV rubber 5 is applied as the coatings, whereby the cracks or the like drawback can be prevented by the thermal stress relaxation of the resin mold 3, and the coiled metal-made shields 4a and 4b are disposed and are electrically connected with the metal-made flanges 2a, whereby even in a case where gaps have appeared between the RTV rubber 5 and the resin mold 3, the electric fields of the parts around the edge parts 21d and the gap parts as form the electric field relaxation-requiring parts can be relaxed, and the occurrences of the partial discharges can be arrested.

Further, the edge part 21c which protrudes in the outer peripheral direction of the vacuum vessel 2, for example, exists as the part of the outer peripheral surface of the vacuum vessel 2 corresponding to that position of the resin mold 3 which is apprehended to incur the crack or the like drawback due to the thermal stress concentration, that is, a part requiring thermal stress relaxation. In order to relax thermal stresses, such thermal stress relaxation-requiring parts are coated with the RTV rubber 5 forming the thermal stress relaxation members, whereupon the coiled metal-made shields 4a and 4b are retained before the vulcanization of the RTV rubber 5 in such a manner that parts of these coiled metal-made shields 4a and 4b are embedded in the RTV rubber 5.

The RTV rubber 5 is applied as the coatings, whereby an effect equivalent to the above is attained regarding the prevention of the cracks or the like drawbacks, by the thermal stress relaxation of the resin mold 3, and the coiled metal-made shields 4a and 4b are disposed still nearer to the edge parts 21d and are electrically connected with the metal-made flanges 2a, whereby an effect equivalent to the above is attained regarding the electric field relaxation of the gap parts, and besides, the electric fields around the edge parts 21d being the electric field relaxation-requiring parts can be relaxed still more, and the occurrences of the partial discharges can be arrested.

Besides, the RTV rubber 5 is set as a paintable type which permits painting onto the surface of this RTV rubber 5 after the vulcanization thereof, and a conductive or semi-conductive coating material 6 with which an intenser adhesive force for the epoxy is attained than for the RTV rubber is applied onto, at least, those parts of the outer peripheral surfaces of the RTV rubber 5 which come into touch with the coiled metal-made shields 4a and 4b, after the vulcanization, so as to communicate with the outer peripheral surfaces of the metal flanges 2a.

The conductive or semi-conductive coating material 6 is applied as coatings, whereby even in the case where the gaps have appeared between the RTV rubber 5 and the resin mold 3, the coating material 6 applied so as to communicate with the outer peripheral surfaces of the metal flanges 2a adheres onto the side of the resin mold 3, so that the electric fields of the gap parts can be relaxed, and the occurrences of the partial discharges can be arrested.

On the other hand, the edge part 21c which protrudes in the outer peripheral direction of the vacuum vessel 2, for example, exists as the part of the outer peripheral surface of the vacuum vessel 2 corresponding to that position of the resin mold 3 which is apprehended to incur the crack or the like drawback due to the thermal stress concentration, that is, the part requiring the thermal stress relaxation. In order to relax thermal stresses at such thermal stress relaxation-requiring parts, the connection parts between the metal-made flanges 2a and the insulating tubes 2b are coated with the RTV rubber 5 of the paintable type which permits the painting onto the surface of this RTV rubber 5 after the vulcanization thereof, and after the vulcanization of the RTV rubber 5, the outer peripheral surfaces of the RTV rubber 5 of the paintable type are coated with a coupling agent 7 which joins the RTV rubber 5 and the epoxy resin mold 3, so as to communicate with the outer peripheral surfaces of the insulating tubes 2b.

The thermal stresses of the edge parts 21c which protrude in the outer peripheral direction of the vacuum vessel 2 and which form the thermal stress relaxation-requiring parts are relaxed by the RTV rubber 5, whereby the cracks or the like drawbacks are prevented, and the RTV rubber 5 and the resin mold 3 are joined by the coupling agent 7, whereby the appearance of the gaps forming the cause of the partial discharges between the RTV rubber 5 and the resin mold 3 can be arrested.

Incidentally, although the aspect where the metal-made shields 4a and 4b are disposed as electrostatic shield members has been illustrated in FIGS. 1 and 2, the electrostatic shield members may be made of annular members each of which has an electric conductivity and each of which self-contracts in the radial direction of the vacuum valve 1. Any desired means can be employed as being equivalent to each of the metal-made shields 4a and 4b, as long as it is an annular member being expansible and contractible in the radial direction and the peripheral direction, such as a) conductive plastics, b) a corrugated plate/corrugated wire (formed of a metal stripe, a metal wire or conductive plastics), or c) a C-shaped ring-stripe metal wire having some butt gap.

(1A) In accordance with Embodiment 1 according to this invention, in a switchgear including a vacuum valve 1 wherein a plurality of electrodes 1a and 1b movable relative to each other are disposed within a vacuum vessel 2 which is constituted by a conductive member including a metal flange 2a and a metal tube 2e and an insulating member including an insulating tube 2b, and wherein a resin mold 3 is applied onto the outer peripheral surface of the vacuum vessel 2; annular electrostatic shield members being electrically conductive and self-contracting in the radial direction of the vacuum valve 1, as are formed of coiled metal-made shields 4a and 4b in each of which a coiled metal wire is brought into an annular shape, or the likes are retained on the outer peripheral surface of the vacuum vessel 2, so as to relax the electric fields of the electric field relaxation-requiring parts 21d of the vacuum vessel 2. It is therefore possible to obtain a switchgear including the vacuum valve 1 which prevents partial discharges infallibly and whose reliability is high, owing to the annular electrostatic shield members being electrically conductive and self-contracting in the radial direction of the vacuum valve 1, as are formed of the coiled metal-made shields 4a and 4b, or the likes which are retained on the outer peripheral surface of the vacuum vessel 2.

More specifically, the switchgear is configured including the vacuum valve 1 wherein the stationary electrode 1a and the movable electrode 1b are disposed within the vacuum vessel 2 in which the metal flange 2a, the metal tube 2e and the insulating tube 2b are connected, and wherein the resin mold 3 is applied onto the outer peripheral surface of the vacuum vessel 2, characterized in that the annular electrostatic shield members being electrically conductive and self-contracting in the radial direction of the vacuum valve 1, as are formed of the coiled metal-made shields 4a and 4b in each of which the coiled metal wire is brought into the annular shape, or the likes, are retained on the outer peripheral surfaces of the connection parts between the metal flange 2a and the insulating tube 2b and between the metal tube 2e and the insulating tube 2b, and in the vicinities of the connection parts between the metal flange 2a and the insulating tube 2b and between the metal tube 2e and the insulating tube 2b, on the outer peripheral surfaces of the metal flange 2a and the metal tube 2e, and that the resin mold 3 is thereafter applied onto the outer peripheral surface of the vacuum vessel 2.

Accordingly, the annular electrostatic shield members being electrically conductive and self-contracting in the radial direction of the vacuum valve 1, as are formed of the coiled metal-made shields 4a and 4b or the likes are disposed, and they are electrically connected with the metal-made flange 2a, whereby the electric fields of the edge parts 21d can be relaxed, and the occurrences of the partial discharges can be arrested.

(1B) In accordance with Embodiment 1 according to this invention, in the configuration in the above item (1A), the annular electrostatic shield members being electrically conductive and self-contracting in the radial direction of the vacuum valve 1, as are formed of the coiled metal-made shields 4a and 4b in each of which the coiled metal wire is brought into the annular shape, or the likes, are joined onto the outer peripheral surface of the vacuum vessel 2 by the contractive forces of the annular electrostatic shield members being electrically conductive and self-contracting in the radial direction of the vacuum valve 1, as are formed of the coiled metal-made shields 4a and 4b retained in pressed touch with the outer peripheral surface of the vacuum vessel 2, or the likes. It is therefore possible to obtain a switchgear including the vacuum valve 1 which prevents the partial discharges infallibly and whose reliability is high, owing to the coiled metal-made shields 4a and 4b retained in pressed touch with the outer peripheral surface of the vacuum vessel 2.

More specifically, in the vacuum valve 1 defined in the above item (1A), the switchgear is configured including the vacuum valve 1 characterized in that the annular electrostatic shield members being electrically conductive and self-contracting in the radial direction of the vacuum valve 1, as are formed of the coiled metal-made shields 4a and 4b in each of which the metal wire coiled so as to have an inside diameter larger than the outside diameter of the insulating tube 2b is brought into the annular shape, or the likes, are retained in pressed touch with the vicinities of the connection parts between the metal flange 2a and the insulating tube 2b and between the metal tube 2e and the insulating tube 2b, on the outer peripheral surface of the insulating tube 2b, that the annular electrostatic shield members being electrically conductive and self-contracting in the radial direction of the vacuum valve 1, as are formed of the coiled metal-made shields 4a and 4b retained in the vicinities of the connection parts between the metal flange 2a and the insulating tube 2b and between the metal tube 2e and the insulating tube 2b, on the outer peripheral surfaces of the metal flange 2a and the metal tube 2e, or the likes, are electrically connected, and that the resin mold 3 is thereafter applied onto the outer peripheral surface of the vacuum vessel 2.

Accordingly, the annular electrostatic shield members being electrically conductive and self-contracting in the radial direction of the vacuum valve 1, as are formed of the coiled metal-made shields 4a and 4b or the likes are retained in pressed touch with the connection parts between the metal flange 2a and the insulating tube 2b and between the metal tube 2e and the insulating tube 2b, on the outer peripheral surface of the insulating tube 2b, thereby to dispose the annular electrostatic shield members being electrically conductive and self-contracting in the radial direction of the vacuum valve 1, as are formed of the coiled metal-made shields 4a and 4b or the likes, and they are electrically connected with the metal-made flange 2a, whereby the electric fields of the edge parts 21d can be relaxed, and the occurrences of the partial discharges can be arrested.

(1C) In accordance with Embodiment 1 according to this invention, in the configuration in the above item (1A) or the above item (1B), the annular electrostatic shield members being electrically conductive and self-contracting in the radial direction of the vacuum valve 1, as are formed of the coiled metal-made shields 4a and 4b or the likes, are retained on silicone rubber members which are made of an RTV rubber 5 vulcanized and molded around the connection parts between the conductive member including the metal flange 2a and the metal tube 2e and the insulating member including the insulating tube 2b. It is therefore possible to obtain a switchgear including the vacuum valve 1 which prevents the partial discharges infallibly and whose reliability is high, owing to the annular electrostatic shield members being electrically conductive and self-contracting in the radial direction of the vacuum valve 1, as are formed of the coiled metal-made shields 4a and 4b retained on the silicone rubber members which are made of the RTV rubber 5 vulcanized and molded around the connection parts between the conductive member including the metal flange 2a and the metal tube 2e and the insulating member including the insulating tube 2b, on the outer peripheral surface of the vacuum vessel 2, or the likes.

More specifically, the switchgear is configured including the vacuum valve 1 defined in the above item (1A) or the above item (1B), characterized in that, after the RTV rubber 5 has been applied as coatings around the connection parts between the metal flange 2a and the insulating tube 2b and between the metal tube 2e and the insulating tube 2b, the annular electrostatic shield members being electrically conductive and self-contracting in the radial direction of the vacuum valve 1, as are formed of the coiled metal-made shields 4a and 4b or the likes, are retained after the vulcanization of the RTV rubber 5, and that the resin mold 3 is applied onto the outer peripheral surface of the vacuum vessel 2 after the retention of the annular electrostatic shield members being electrically conductive and self-contracting in the radial direction of the vacuum valve 1, as are formed of the coiled metal-made shields 4a and 4b or the likes.

Accordingly, in addition to the advantage stated in the above item (1A) or the above item (1B), the thermal stresses of edge parts 21c can be relaxed, and the appearance of cracks or the like drawbacks can be arrested, owing to the RTV rubber 5.

(1D) In accordance with Embodiment 1 according to this invention, in the configuration in the above item (1A) or the above item (1B), the silicone rubber members made of the RTV rubber 5 are disposed, the RTV rubber 5 being vulcanized and molded around the connection parts between the conductive member including the metal flange 2a and the metal tube 2e and the insulating member including the insulating tube 2b, in a state where parts of the annular electrostatic shield members being electrically conductive and self-contracting in the radial direction of the vacuum valve 1, as are formed of the coiled metal-made shields 4a and 4b or the likes, are embedded in the RTV rubber 5. It is therefore possible to obtain a switchgear including the vacuum valve 1 which prevents the partial discharges infallibly and whose reliability is high, owing to the annular electrostatic shield members being electrically conductive and self-contracting in the radial direction of the vacuum valve 1, as are formed of the coiled metal-made shields 4a and 4b retained in the state where they are partially embedded in the silicone rubber members made of the RTV rubber 5 which is vulcanized and molded around the connection parts between the conductive member including the metal flange 2a and the metal tube 2e and the insulating member including the insulating tube 2b, on the outer peripheral surface of the vacuum vessel 2, or the likes.

More specifically, the switchgear is configured including the vacuum valve 1 defined in the above item (1A) or the above item (1B), characterized in that, after the RTV rubber 5 has been applied as a coating around the connection parts between the metal flange 2a and the insulating tube 2b and between the metal tube 2e and the insulating tube 2b, the annular electrostatic shield members being electrically conductive and self-contracting in the radial direction of the vacuum valve 1, as are formed of the coiled metal-made shields 4a and 4b or the likes, are retained on the RTV rubber 5 in the state where they are partially embedded in the RTV rubber 5, before the vulcanization of the RTV rubber 5, and that the resin mold 3 is applied onto the outer peripheral surface of the vacuum vessel 2 after the vulcanization of the RTV rubber 5.

Accordingly, in addition to the advantage stated in the above item (1A) or the above item (1B), the thermal stresses of the edge parts 21c can be relaxed, and the appearance of the cracks or the like drawbacks can be arrested, owing to the RTV rubber 5 in which the parts of the annular electrostatic shield members being electrically conductive and self-contracting in the radial direction of the vacuum valve 1, as are formed of the coiled metal-made shields 4a and 4b or the likes, are embedded.

(1E) In accordance with Embodiment 1 according to this invention, in the configuration in the above item (1C) or the above item (1D), conductive or semi-conductive coating material layers 6 are disposed so as to be conductive with the conductive member including the metal flange 2a and the metal tube 2e, on at least those parts of the outer peripheral surfaces of the silicone rubber members made of the RTV rubber 5 which touch the annular electrostatic shield members being electrically conductive and self-contracting in the radial direction of the vacuum valve 1, as are formed of the coiled metal-made shields 4a and 4b or the likes. It is therefore possible to obtain a switchgear including the vacuum valve 1 which prevents the partial discharges infallibly and whose reliability is high, owing to the conductive or semi-conductive coating material layers 6 which are disposed so as to be conductive with the conductive member including the metal flange 2a and the metal tube 2e, on at least those parts of the outer peripheral surfaces of the silicone rubber members made of the RTV rubber 5 which touch the annular electrostatic shield members being electrically conductive and self-contracting in the radial direction of the vacuum valve 1, as are formed of the coiled metal-made shields 4a and 4b or the likes.

More specifically, in the vacuum valve 1 defined in the above item (1C) or the above item (1D), there is configured the vacuum valve 1 characterized in that the RTV rubber 5 is of paintable type, that at least those parts of the outer peripheral surfaces of the RTV rubber 5 which touch the annular electrostatic shield members being electrically conductive and self-contracting in the radial direction of the vacuum valve 1, as are formed of the coiled metal-made shields 4a and 4b or the likes, are coated with the conductive or semi-conductive coating material 6 so as to communicate with the outer peripheral surfaces of the metal flange 2a and the metal tube 2e, and that the resin mold 3 is applied onto the outer peripheral surface of the vacuum vessel 2 after the drying of the coating material 6.

Accordingly, in addition to the advantage stated in the above item (1C) or the above item (1D), the conductive or semi-conductive coating material 6 is applied as the coating so as to communicate with the outer peripheral surface of the metal flange 2a, whereby even in a case where any gap ascribable to a temperature change has appeared between the RTV rubber 5 and the resin mold 3, the coating material 6 adheres onto the side of the resin mold 3, so that the electric field of the gap part can be relaxed, and the occurrence of the partial discharge can be arrested.

(1F) In accordance with Embodiment 1 according to this invention, in the configuration in the above item (1C) or the above item (1D), coupling layers made of a coupling agent 7 are interposed between the outer peripheral surfaces of the silicone rubber members made of the RTV rubber 5 and the resin mold 3. It is therefore possible to obtain a switchgear including the vacuum valve 1 which prevents the partial discharges infallibly and whose reliability is high, owing to the coupling layers made of the coupling agent 7 as are interposed between the outer peripheral surfaces of the silicone rubber members made of the RTV rubber 5 and the resin mold 3.

More specifically, the switchgear is configured including the vacuum valve 1 defined in the above item (1C) or the above item (1D), characterized in that the RTV rubber 5 is of paintable type, that the outer peripheral surfaces of the RTV rubber 5 of the paintable type is coated with the coupling agent 7 so as to communicate with the outer peripheral surface of the insulating tube 2b, and that the resin mold 3 is thereafter applied onto the outer peripheral surface of the vacuum vessel 2.

Accordingly, in addition to the advantage stated in the above item (1C) or the above item (1D), the RTV rubber 5 and the resin mold 3 are joined by the coupling agent 7, whereby the appearance of any gap forming a cause for the partial discharge between the RTV rubber 5 and the resin mold 3 can be arrested.

(1G) In accordance with Embodiment 1 according to this invention, a fabrication for a switchgear including a vacuum valve 1 wherein a plurality of electrodes 1a and 1b movable relative to each other are disposed within a vacuum vessel 2 which is constituted by a conductive member including a metal flange 2a and a metal tube 2e and an insulating member including an insulating tube 2b, and wherein a resin mold 3 is applied onto the outer peripheral surface of the vacuum vessel 2, is characterized in that annular electrostatic shield members being electrically conductive and being expansible and contractible in the radial direction and peripheral direction of the vacuum valve 1, as are formed of coiled metal-made shields 4a and 4b in each of which a coiled metal wire is brought into an annular shape so as to have an inside diameter smaller than the outside diameter of the vacuum vessel 2, or the likes, are retained in the vicinities of the connection parts between the conductive member including the metal flange 2a and the metal tube 2e and the insulating member including the insulating tube 2b, on the outer peripheral surface of the vacuum vessel 2, in a state where the annular electrostatic shield members hold their compressive forces in the radial direction of the vacuum valve 1, that the annular electrostatic shield members being electrically conductive and being expansible and contractible in the radial direction and peripheral direction of the vacuum valve 1, as are formed of the conductive member including the metal flange 2a and the metal tube 2e and the coiled metal-made shields 4a and 4b, or the likes are electrically connected, and that the resin mold 3 is thereafter applied onto the outer peripheral surface of the vacuum vessel 2. It is therefore possible to obtain a method of fabricating a switchgear including the vacuum valve 1 which prevents partial discharges infallibly and whose reliability is high, by applying the resin mold 3 in a state where the annular electrostatic shield members being electrically conductive and being expansible and contractible in the radial direction and peripheral direction of the vacuum valve 1, as are formed of the coiled metal-made shields 4a and 4b or the likes, are retained in pressed touch with the outer peripheral surface of the vacuum vessel 2.

More specifically, the method of fabricating the switchgear including the vacuum valve 1 is characterized in that, in the vacuum valve 1 defined in the above item (1A), the annular electrostatic shield members being electrically conductive and being expansible and contractible in the radial direction and peripheral direction of the vacuum valve 1, as are formed of the coiled metal-made shields 4a and 4b in each of which the coiled metal wire is brought into the annular shape so as to have the inside diameter smaller than the outside diameter of the insulating tube 2b, or the likes, are retained on that outer peripheral surface of the insulating tube 2b which is vicinal to the connection parts between the metal flange 2a and the insulating tube 2b and between the metal tube 2e and the insulating tube 2b, that the annular electrostatic shield members being electrically conductive and being expansible and contractible in the radial direction and peripheral direction of the vacuum valve 1, as are formed of the coiled metal-made shields 4a and 4b or the likes and are retained on those outer peripheral surfaces of the metal flange 2a and the metal tube 2e which are vicinal to the connection parts between the metal flange 2a and the insulating tube 2b and between the metal tube 2e and the insulating tube 2b, are electrically connected, and that the resin mold 3 is thereafter applied onto the outer peripheral surface of the vacuum vessel 2.

Accordingly, it is possible to obtain the method of fabricating the switchgear including the vacuum valve 1 which can relax the electric fields of edge parts 21d and which can arrest the occurrences of the partial discharges, in such a way that the annular electrostatic shield members being electrically conductive and being expansible and contractible in the radial direction and peripheral direction of the vacuum valve 1, as are formed of the coiled metal-made shields 4a and 4b or the likes, are disposed, and that they are electrically connected with the metal-made flange 2a.

(1H) In accordance with Embodiment 1 according to this invention, the contents of the method in the above item (1G) are characterized in that silicone rubber made of an RTV rubber 5 is applied as coatings around the connection parts between the conductive member including the metal flange 2a and the metal tube 2e and the insulating member including the insulating tube 2b, that the annular electrostatic shield members being electrically conductive and being expansible and contractible in the radial direction and peripheral direction of the vacuum valve 1, as are formed of the coiled metal-made shields 4a and 4b or the likes, are subsequently retained after the vulcanization of the silicone rubber made of the RTV rubber 5, and that the resin mold 3 is applied onto the outer peripheral surface of the vacuum vessel 2 after the retention of the annular electrostatic shield members being electrically conductive and being expansible and contractible in the radial direction and peripheral direction of the vacuum valve 1, as are formed of the coiled metal-made shields 4a and 4b or the likes. It is therefore possible to obtain a method of fabricating a switchgear including the vacuum valve 1 which prevents the partial discharges infallibly and whose reliability is high, in such a way that the annular electrostatic shield members being electrically conductive and being expansible and contractible in the radial direction and peripheral direction of the vacuum valve 1, as are formed of the coiled metal-made shields 4a and 4b or the likes, are retained on the silicone rubber members made of the RTV rubber 5 as are vulcanized and molded around the connection parts between the conductive member including the metal flange 2a and the metal tube 2e and the insulating member including the insulating tube 2b, on the outer peripheral surface of the vacuum vessel 2.

More specifically, in the method of fabricating the switchgear including the vacuum valve 1 as defined in the above item (1G), the method of fabricating the vacuum valve 1 is characterized in that the RTV rubber 5 is applied as the coatings around the connection parts between the metal flange 2a and the insulating tube 2b and between the metal tube 2e and the insulating tube 2b, that the annular electrostatic shield members being electrically conductive and being expansible and contractible in the radial direction and peripheral direction of the vacuum valve 1, as are formed of the coiled metal-made shields 4a and 4b or the likes, are subsequently retained after the vulcanization of the RTV rubber 5, and that the resin mold 3 is applied onto the outer peripheral surface of the vacuum vessel 2 after the retention of the annular electrostatic shield members being electrically conductive and being expansible and contractible in the radial direction and peripheral direction of the vacuum valve 1, as are formed of the coiled metal-made shields 4a and 4b or the likes.

Accordingly, in addition to the advantage stated in the above item (1G), the thermal stresses of edge parts 21c can be relaxed, and the appearance of cracks or the like drawbacks can be arrested, by the RTV rubber 5.

(1I) In accordance with Embodiment 1 according to this invention, the contents of the method in the above item (1G) are characterized in that silicone rubber made of an RTV rubber 5 is applied as coatings around the connection parts between the conductive member including the metal flange 2a and the metal tube 2e and the insulating member including the insulating tube 2b, that the annular electrostatic shield members being electrically conductive and being expansible and contractible in the radial direction and peripheral direction of the vacuum valve 1, as are formed of the coiled metal-made shields 4a and 4b or the likes, are subsequently retained in a state where they are partially embedded in the silicone rubber made of the RTV rubber 5, before vulcanization of the silicone rubber made of the RTV rubber 5, and that the resin mold 3 is applied onto the outer peripheral surface of the vacuum vessel 2 after the vulcanization of the silicone rubber made of the RTV rubber 5. It is therefore possible to obtain a method of fabricating a switchgear including the vacuum valve 1 which prevents the partial discharges infallibly and whose reliability is high, in such a way that the annular electrostatic shield members being electrically conductive and being expansible and contractible in the radial direction and peripheral direction of the vacuum valve 1, as are formed of the coiled metal-made shields 4a and 4b or the likes, are retained in the state where they are partially embedded in the silicone rubber members made of the RTV rubber 5 as are vulcanized and molded around the connection parts between the conductive member including the metal flange 2a and the metal tube 2e and the insulating member including the insulating tube 2b, on the outer peripheral surface of the vacuum vessel 2.

More specifically, in the method of fabricating the switchgear including the vacuum valve 1 as defined in the above item (1G), the method of fabricating the vacuum valve 1 is characterized in that the RTV rubber is applied as the coatings around the connection parts between the metal flange 2a and the insulating tube 2b and between the metal tube 2e and the insulating tube 2b, that the annular electrostatic shield members being electrically conductive and being expansible and contractible in the radial direction and peripheral direction of the vacuum valve 1, as are formed of the coiled metal-made shields 4a and 4b or the likes, are subsequently retained in the state where they are partially embedded in the RTV rubber 5, before the vulcanization of the RTV rubber 5, and that the resin mold 3 is applied onto the outer peripheral surface of the vacuum vessel 2 after the vulcanization of the RTV rubber 5.

Accordingly, in addition to the advantage stated in the above item (1G), the thermal stresses of edge parts 21c can be relaxed, and the appearance of cracks or the like drawbacks can be arrested, by the RTV rubber 5 in which the coiled metal-made shields 4a and 4b are partially embedded.

(1J) In accordance with Embodiment 1 according to this invention, the contents of the method in the above item (1H) or item (1I) are characterized in that the silicone rubber made of the RTV rubber 5 is of paintable type, that at least those parts of outer peripheral surfaces of the silicone rubber which touch the annular electrostatic shield members being electrically conductive and being expansible and contractible in the radial direction and peripheral direction of the vacuum valve 1, as are formed of the coiled metal-made shields 4a and 4b or the likes, are coated with a conductive or semi-conductive coating material so as to be conductive with the conductive member including the metal flange 2a and the metal tube 2e, and that the resin mold 3 is applied onto the outer peripheral surface of the vacuum vessel 2 after drying of the coating material. It is therefore possible to obtain a method of fabricating a switchgear including the vacuum valve 1 which prevents the partial discharges infallibly and whose reliability is high, in such a way that at least those parts of the outer peripheral surfaces of the silicone rubber members made of the RTV rubber 5 which touch the annular electrostatic shield members being electrically conductive and being expansible and contractible in the radial direction and peripheral direction of the vacuum valve 1, as are formed of the coiled metal-made shields 4a and 4b or the likes, are coated with the conductive or semi-conductive coating material layers 6 which are disposed so as to be conductive with the conductive member including the metal flange 2a and the metal tube 2e.

More specifically, in the vacuum valve 1 defined in the above item (1H) or the above item (1I), the method of fabricating the switchgear including the vacuum valve 1 is characterized in that the RTV rubber 5 is of the paintable type, that at least those parts of the outer peripheral surfaces of the RTV rubber 5 which touch the annular electrostatic shield members being electrically conductive and being expansible and contractible in the radial direction and peripheral direction of the vacuum valve 1, as are formed of the coiled metal-made shields 4a and 4b or the likes, are coated with the conductive or semi-conductive coating material 6 so as to communicate with the outer peripheral surfaces of the metal flange 2a and the metal tube 2e, and that the resin mold 3 is applied onto the outer peripheral surface of the vacuum vessel 2 after the drying of the coating material.

Accordingly, in addition to the advantage stated in the above item (1H) or the above item (1I), the conductive or semi-conductive coating material 6 is applied as a coating so as to communicate with the outer peripheral surface of the metal flange 2a, whereby the coating material 6 adheres onto the side of the resin mold 3 even in a case where a gap ascribable to a temperature change has appeared between the RTV rubber 5 and the resin mold 3, so that the electric field of the gap part can be relaxed, and the occurrence of a partial discharge can be arrested.

(1K) In accordance with Embodiment 1 according to this invention, the contents of the method in the above item (1H) or item (1I) are characterized in that the silicone rubber made of the RTV rubber 5 is of paintable type, that a coupling agent 7 is applied as a coating onto the outer peripheral surface of the silicone rubber made of the RTV rubber 5 of the paintable type so as to communicate with the outer peripheral surface of the insulating member including the insulating tube 2b, and that the resin mold 3 is thereafter applied onto the outer peripheral surface of the vacuum vessel 2. It is therefore possible to obtain a method of fabricating a switchgear including the vacuum valve 1 which prevents the partial discharges infallibly and whose reliability is high, in such a way that a coupling layer which is made of the coupling agent 7 interposed between the outer peripheral surface of the silicone rubber member made of the RTV rubber 5 and the resin mold 3 is applied as the coating.

More specifically, in the vacuum valve 1 defined in the above item (1H) or (1I), the method of fabricating the switchgear including the vacuum valve 1 is characterized in that the RTV rubber is of the paintable type, that the coupling agent 7 is applied as the coating onto the outer peripheral surface of the RTV rubber 5 of the paintable type so as to communicate with the outer peripheral surface of the insulating tube 2b, and that the resin mold 3 is thereafter applied onto the outer peripheral surface of the vacuum vessel 2.

Accordingly, in addition to the advantage stated in the above item (1H) or the above item (1I), the RTV rubber 5 and the resin mold 3 are joined by the coupling agent 7, whereby the appearance of any gap forming a cause for the partial discharge between the RTV rubber 5 and the resin mold 3 can be arrested.

### Embodiment 2

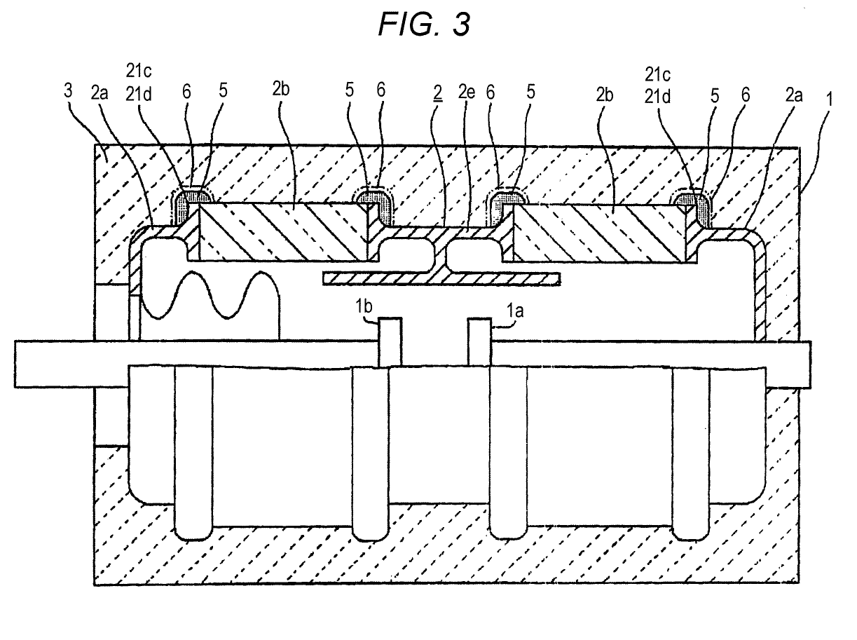

Embodiment 2 according to this invention will be described in conjunction with FIG. 3. FIG. 3 is a sectional view, partially cut away, showing the configuration of a switchgear which includes a vacuum valve 1 in Embodiment 2.

In this embodiment 2, regarding a configuration except a peculiar configuration to be described here, the same configurational contents and method contents as in the configuration and method in the foregoing embodiment 1 are included, and they perform similar operations. In the drawings, the same numerals and signs indicate the same or equivalent portions.

Referring to FIG. 3, the vacuum valve 1 is configured of a stationary electrode 1a and a movable electrode 1b, a vacuum vessel 2 which includes a metal-made flange 2a as well as a metal tube 2e and a ceramics-made insulating tube 2b and in which the electrodes 1a and 1b are accommodated, and a resin mold 3 being an outer-peripheral insulator which covers the outer peripheral surface of the vacuum vessel 2. Sign 21c denotes the thermal stress concentration part of the vacuum vessel 2, and sign 21d the electric field concentration part of the vacuum vessel 2.

The edge part 21c which protrudes in the outer peripheral direction of the vacuum vessel 2, for example, exists as the part of the outer peripheral surface of the vacuum vessel 2 corresponding to that position of the resin mold 3 which is apprehended to incur a crack or the like drawback due to thermal stress concentration, that is, a part requiring thermal stress relaxation. In order to relax thermal stresses at such thermal stress relaxation-requiring parts, the connection parts between the metal-made flanges 2a and the insulating tubes 2b are coated with an RTV rubber 5 of paintable type which permits painting onto the surface of this RTV rubber 5 after the vulcanization thereof, and after the vulcanization of the RTV rubber 5, the outer peripheral surfaces of the RTV rubber of the paintable type are coated with a conductive or semi-conductive coating material 6 with which an intenser adhesive force for epoxy is attained than for the RTV rubber, so as to communicate with the outer peripheral surfaces of the metal flanges 2a.

Owing to the RTV rubber 5, the thermal stresses of the edge parts 21c protruding in the outer peripheral direction of the vacuum vessel 2 as are the thermal stress relaxation-requiring parts are relaxed, thereby to prevent the cracks or the like drawbacks, and even in a case where gaps have appeared between the RTV rubber 5 and the resin mold 3, the coating material 6 applied as coatings so as to communicate with the outer peripheral surfaces of the metal flanges 2a adheres onto the side of the resin mold 3, so that the electric fields of the edge parts 21d and the gap parts can be relaxed, and the appearance of partial discharges can be arrested.

(2A) In accordance with Embodiment 2 according to this invention, in a switchgear including a vacuum valve 1 wherein a plurality of electrodes 1a and 1b movable relative to each other are disposed within a vacuum vessel 2 which is constituted by a conductive member including a metal flange 2a and a metal tube 2e and an insulating member including an insulating tube 2b, and wherein a resin mold 3 is applied onto the outer peripheral surface of the vacuum vessel 2; conductive or semi-conductive coating material layers 6 are disposed on the outer peripheral surfaces of silicone rubber made of an RTV rubber 5 of paintable type as is vulcanized and formed on the outer peripheral surfaces of the conductive member including the metal flange 2a and the metal tube 2e and the insulating member including the insulating tube 2b, around the connection parts between the conductive member including the metal flange 2a and the metal tube 2e and the insulating member including the insulating tube 2b, so as to be conductive with the conductive member including the metal flange 2a and the metal tube 2e, and the resin mold 3 is applied onto the outer peripheral surface of the vacuum vessel 2. It is therefore possible to obtain a switchgear including the vacuum valve 1 which prevents partial discharges infallibly and whose reliability is high, by the conductive or semi-conductive coating material layers 6.

More specifically, the switchgear is configured including the vacuum valve 1 wherein the stationary electrode and the movable electrode are disposed within the vacuum vessel 2 in which the metal flange 2a as well as the metal tube 2e and the insulating tube 2b are connected, and wherein the resin mold 3 is applied onto the outer peripheral surface of the vacuum vessel 2, characterized in that the RTV rubber 5 of the paintable type is applied as coatings onto the outer peripheral surfaces of the metal flange 2a as well as the metal tube 2e and the insulating tube 2b, around the connection parts between the metal flange 2a and the insulating tube 2b and between the metal tube 2e and the insulating tube 2b, that after the vulcanization of the RTV rubber 5, the conductive or semi-conductive coating material 6 is applied as coatings onto the outer peripheral surfaces of the RTV rubber 5 of the paintable type so as to communicate with the outer peripheral surfaces of the metal flange 2a and the metal tube 2e, and that after the drying of the coating material 6, the resin mold 3 is applied onto the outer peripheral surface of the vacuum vessel 2.

Accordingly, owing to the RTV rubber 5, the thermal stresses of the edge parts 21c protruding in the outer peripheral direction of the vacuum vessel 2 as are the thermal stress relaxation-requiring parts are relaxed, thereby to prevent cracks or the like drawbacks, and even in a case where gaps have appeared between the RTV rubber 5 and the resin mold 3, the coating material 6 applied as the coating so as to communicate with the outer peripheral surface of the metal flange 2a adheres onto the side of the resin mold 3, so that the electric fields of the edge parts 21d and the gap parts can be relaxed, and the occurrences of the partial discharges can be arrested.

(2B) In accordance with Embodiment 2 according to this invention, in fabricating a switchgear including a vacuum valve 1 wherein a plurality of electrodes 1a and 1b movable relative to each other are disposed within a vacuum vessel 2 which is constituted by a conductive member including a metal flange 2a and a metal tube 2e and an insulating member including an insulating tube 2b, and wherein a resin mold 3 is applied onto the outer peripheral surface of the vacuum vessel 2; silicone rubber made of an RTV rubber 5 of paintable type is applied as coatings onto the outer peripheral surfaces of the conductive member including the metal flange 2a and the metal tube 2e and the insulating member including the insulating tube 2b, around the connection parts between the conductive member including the metal flange 2a and the metal tube 2e and the insulating member including the insulating tube 2b, a conductive or semi-conductive coating material 6 is applied as coatings onto the outer peripheral surfaces of the silicone rubber made of the RTV rubber 5 of the paintable type after the vulcanization of the silicone rubber, so as to be conductive with the outer peripheral surfaces of the conductive member including the metal flange 2a and the metal tube 2e, and the resin mold 3 is applied onto the outer peripheral surface of the vacuum vessel 2 after the drying of the coating material 6. It is therefore possible to obtain a method of fabricating a switchgear including the vacuum valve 1 which prevents partial discharges infallibly and whose reliability is high, in such a way that the conductive or semi-conductive coating material layers 6 are applied as the coatings.

More specifically, the method of fabricating the vacuum valve 1 wherein the stationary electrode and the movable electrode are disposed within the vacuum vessel 2 in which the metal flange 2a as well as the metal tube 2e and the insulating tube 2b are connected, and wherein the resin mold 3 is applied onto the outer peripheral surface of the vacuum vessel 2, is characterized in that the RTV rubber 5 of the paintable type is applied as the coatings onto the outer peripheral surfaces of the metal flange 2a, the metal tube 2e and the insulating tube 2b, around the connection parts between the metal flange 2a and the insulating tube 2b and between the metal tube 2e and the insulating tube 2b, that after the vulcanization of the RTV rubber 5, the conductive or semi-conductive coating material 6 is applied as the coatings onto the outer peripheral surfaces of the RTV rubber 5 of the paintable type so as to communicate with the outer peripheral surfaces of the metal flange 2a and the metal tube 2e, and that after the drying of the coating material 6, the resin mold 3 is applied onto the outer peripheral surface of the vacuum vessel 2.

Accordingly, owing to the RTV rubber 5, the thermal stresses of the edge parts 21c protruding in the outer peripheral direction of the vacuum vessel 2 as are the thermal stress relaxation-requiring parts are relaxed, thereby to prevent cracks or the like drawbacks, and even in a case where gaps have appeared between the RTV rubber 5 and the resin mold 3, the coating material 6 applied as the coating so as to communicate with the outer peripheral surface of the metal flange 2a adheres onto the side of the resin mold 3, so that the electric fields of the edge parts 21d and the gap parts can be relaxed, and the occurrences of the partial discharges can be arrested.

This invention relates to a vacuum valve 1 in which a resin mold 3 is applied onto the outer peripheral surface of a vacuum vessel 2, and a method of fabricating the same, and in more detail, it can be utilized for thermal stress relaxation and electric field relaxation which arrest the occurrences of cracks, partial discharges, etc. that develop in the resin mold 3 when this resin mold 3 has undergone a temperature change.

1-14. (canceled)

15. A switchgear including a vacuum valve in which a plurality of electrodes movable relative to each other is disposed within a vacuum vessel constituted by a conductive member and an insulating member, and a resin mold is applied onto an outer peripheral surface of the vacuum vessel, wherein an annular electrostatic shield member which contracts in its radial direction is retained on the outer peripheral surface of the vacuum vessel so as to relax an electric field of an electric field relaxation-requiring part of the vacuum vessel;
wherein:
a shield member, in which at least two rings each having a coiled metal wire in an annular shape are electrically connected, is employed as the electrostatic shield member; and
the electrostatic shield member is joined onto the outer peripheral surface of the vacuum vessel by a contracting force of the electrostatic shield member.

16. A switchgear as defined in claim 15, wherein the electrostatic shield member is retained on a silicone rubber member which is vulcanized and molded around a connection part between the conductive member and the insulating member.

17. A switchgear as defined in claim 15, wherein a silicone rubber member which is vulcanized and molded in a state where part of the electrostatic shield member is embedded therein is disposed around a connection part between a conductive member and an insulating member.

18. A switchgear as defined in claim 16, wherein a conductive or semi-conductive coating material layer is disposed so as to be conductive with the conductive member, on at least that part of an outer peripheral surface of the silicone rubber member which touches the electrostatic shield member.

19. A switchgear as defined in claim 16, wherein a coupling layer made of a coupling agent is interposed between an outer peripheral surface of the silicone rubber member and the resin mold.

20. A method of fabricating a switchgear including a vacuum valve in which a plurality of electrodes movable relative to each other is disposed within a vacuum vessel which is constituted by a conductive member and an insulating member, and a resin mold is applied onto an outer peripheral surface of the vacuum vessel; wherein an annular electrostatic shield member which is expansible and contractible in a radial direction and which is endowed with an inside diameter smaller than an outside diameter of the vacuum vessel is retained in the vicinity of a connection part between the conductive member and the insulating member, on the outer peripheral surface of the vacuum vessel, in a state where the annular electrostatic shield member holds its compressive force in the radial direction, the conductive member and the electrostatic shield member are electrically connected, and the resin mold is thereafter applied onto the outer peripheral surface of the vacuum vessel.

21. A method of fabricating a switchgear including a vacuum valve as defined in claim 20, wherein silicone rubber is applied as a coating around the connection part between the conductive member and the insulating member, the electrostatic shield member is subsequently retained after vulcanization of the silicone rubber, and the resin mold is applied onto the outer peripheral surface of the vacuum vessel after the retention of the electrostatic shield member.

22. A method of fabricating a switchgear including a vacuum valve as defined in claim 20, wherein silicone rubber is applied as a coating around the connection part between the conductive member and the insulating member, the electrostatic shield member is subsequently retained in a state where it is partially embedded in the silicone rubber, before vulcanization of the silicone rubber, and the resin mold is applied onto the outer peripheral surface of the vacuum vessel after the vulcanization of the silicone rubber.

23. A method of fabricating a switchgear including a vacuum valve as defined in claim 20, wherein the silicone rubber is of paintable type, at least that part of an outer peripheral surface of the silicone rubber which touches the electrostatic shield member is coated with a conductive or semi-conductive coating material so as to be conductive with the conductive member, and the resin mold is applied onto the outer peripheral surface of the vacuum vessel after drying of the coating material.

24. A method of fabricating a switchgear including a vacuum valve as defined in claim 21, wherein the silicone rubber is of paintable type, a coupling agent is applied as a coating onto an outer peripheral surface of the silicone rubber of the paintable type so as to communicate with an outer peripheral surface of the insulating member, and the resin mold is thereafter applied onto the outer peripheral surface of the vacuum vessel.

25. A switchgear including a vacuum valve in which a plurality of electrodes movable relative to each other is disposed within a vacuum vessel constituted by a conductive member and an insulating member, and a resin mold is applied onto an outer peripheral surface of the vacuum vessel; wherein a conductive or semi-conductive coating material layer is disposed so as to be conductive with the conductive member, on an outer peripheral surface of silicone rubber of paintable type as is vulcanized and formed on outer peripheral surfaces of the conductive member and the insulating member, around a connection part between the conductive member and the insulating member, and the resin mold is applied onto the outer peripheral surface of the vacuum vessel.

26. A method of fabricating a switchgear including a vacuum valve in which a plurality of electrodes movable relative to each other is disposed within a vacuum vessel which is constituted by a conductive member and an insulating member, and wherein a resin mold is applied onto an outer peripheral surface of the vacuum vessel; wherein
silicone rubber of paintable type is applied as a coating onto outer peripheral surfaces of the conductive member and the insulating member, around a connection part between the conductive member and the insulating member, after
vulcanization of the silicone rubber, a conductive or semi-conductive coating material is applied as a coating onto an outer peripheral surface of the silicone rubber of the paintable type, so as to be conductive with the outer peripheral surface of the conductive member, and
after drying of the coating material, the resin mold is applied onto the outer peripheral surface of the vacuum vessel.
